(19) United States
(12) Patent Application Publication
(10) Pub. No.: US 2001/0000086 A1
(43) Pub. Date: Apr. 5, 2001

(54) Task indicator decals for preventive maintenance and condition monitoring systems

(76) Inventor: Jeffrey Lewis, San Leandro, CA (US)

Correspondence Address: Gary L. Baker, Esq., Patent Attorney & Attorney at Law, 1563 Boxwood Avenue, San Leandro, CA, 94579, US

(21) Appl. No.: 09/729,581

(22) Filed: Dec. 4, 2000

Related U.S. Application Data
(63) Continuation-in-part of application No. 09/366,450, filed on Aug. 3, 1999.
(60) Provisional application No. 60/095,224, filed on Aug. 4, 1998.

(51) Int. Cl. G09F 23/00

(52) U.S. Cl. 40/638

(57) ABSTRACT

The task indicator decals imprinted with coding means including informative colors, symbolic pictographs, alphanumeric descriptors and/or bar codes and having adhesive backing means for mounting on equipment or equipment components to express preventive maintenance or condition monitoring task information at the point of service. Computer directed processes of making task indicator decals and the use of task indicator decals in preventive maintenance or condition monitoring systems.

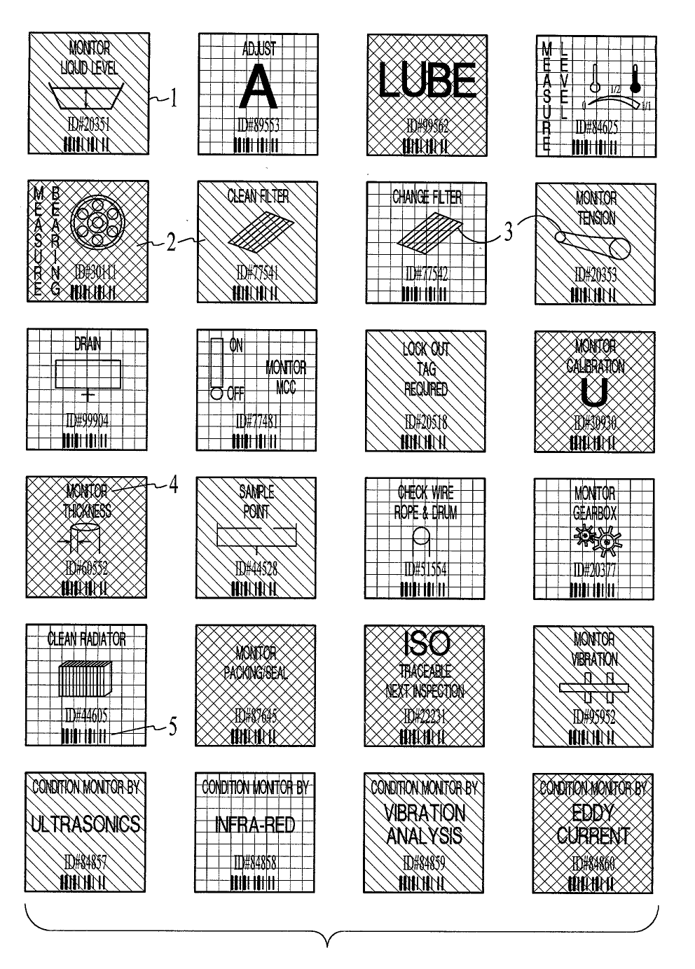

### BACKGROUND OF THE INVENTION

1. 1. Field of the Invention

2. This invention relates to task indicator decals for increasing the efficiency of preventive maintenance and condition monitoring systems. The task indicator decals using colors, symbols, alphanumeric characters or bar-codes to provide condition monitoring or preventive maintenance information at the point of service on industrial equipment and equipment components.

3. 2. Definitions

4. Condition Monitoring—Routine scheduled inspection of equipment and components to predict the time of breakdown by statistical regression analysis of data gathered on parameters correlated to equipment failure. Condition monitoring allows equipment adjustments or component replacement to be scheduled just in time as required to prevent breakdown.

5. Inspection Period—Time period between scheduled inspections of equipment or components.

6. Point of Service—Equipment or component location for preventive maintenance or condition monitoring activities.

7. Preventive Maintenance—Periodically scheduled adjustments or component replacement to prevent equipment breakdown.

8. 3. Description of Related Art

9. The original art of equipment maintenance was simply “If it isn't broke, don't fix it”. Later, the concept of preventive maintenance required equipment calibration or component replacement on a ridged schedule to prevent breakdowns at the earliest time such breakdowns would be expected to occur. The preventive maintenance inspection schedules can be complex with several measurements required at various inspection periods for components on many pieces of equipment. A maintenance technician with a check list schedule of maintenance tasks must move from location to location inspecting equipment and components. Often the technician has trouble locating the point of service. The technician must continually refer to the maintenance schedule to determine when servicing is due and what testing must be performed. In addition, daily users of equipment, who might be the first to notice problems occurring, have no ready indication of what components are important to watch.

10. The current state of the preventive maintenance art includes condition monitoring to follow the rate of change in failure correlated parameters. By following statistical regression analysis of the failure correlated parameters, the time of failure can be predicted and maintenance performed just in time. By predicting component failure through condition monitoring, wasteful unnecessary repair or replacement can be avoided. For example, statistical regression analysis of a bearing temperatures can predict failure of individual bearings so all bearings do not have to be replaced before the earliest known failure date. As in preventive maintenance, a technician experiences the difficulties associated with working from a written inspection schedule.

11. Current condition monitoring and preventive maintenance systems often employ identification stickers on equipment and occasionally on equipment components. The technician can only identify the equipment using current stickers then must refer to the inspection schedule for information on the inspection period, the required task and adjustment parameters. The technician must read the ID number from the sticker and transcribe the ID number to his records. Training is slow without visual cues and changes to the schedule are not apparent from the stickers. The old sticker systems fail to employ the flexibility of computerized data management systems, bar-code readers and computer directed printing. Changes in the inspection schedule are not readily apparent at the point of service by application of a new sticker.

12. The present invention employs task identifier decals to simplify maintenance and monitoring tasks by affixing easily interpreted condition monitoring and preventive maintenance information at the point of service with task indicator decals. Visual inspection of equipment can inform service technicians of maintenance tasks and inspection periods without continuous reference to the maintenance schedule. New maintenance technicians can become familiar with all the equipment and components maintenance requirements in less time. In addition, bar-codes on the task indicator decals can facilitate entry and retrieval of conditioning monitoring and preventive maintenance information relevant to the labeled equipment or component. Equipment users, not specialized in preventive maintenance, can see what components require attention and may inform management if the inspection period has lapsed. Such informative decals are readily produced using commonly available computer software and digital printers.

### SUMMARY OF THE INVENTION

13. It is an objective of this invention to provide a coded task indicator decals employing color coding, symbolic pictograph coding, alphanumeric character coding and bar-code coding to be for affixed at the point of service location to expedite condition monitoring and preventive maintenance tasks on industrial equipment and components. The display surface of task indicator decals may be imprinted with a variety of coding means such as color, symbolic pictographs, alphanumeric descriptors and/or bar-codes.

14. Color codes printed on the decals may indicate relevant condition monitoring parameters, particularly condition monitoring and preventive maintenance inspection periods or required maintenance functions, for easy interpretation without close up examination. A technician doing weekly inspections can disregard decals color coded for monthly inspection. The color coded decals may be interpreted from a distance so the technician does not have to approach every point of service.

15. Symbolic pictograph codes, such as graduated cylinders (monitor liquid level), pulley and belt (monitor pulley tension), a thermometer (monitor temperature), a filter (clean filter) or other symbols appropriate to various industries and functions, may be employed to quickly communicate required condition monitoring and preventive maintenance activities. Symbolic pictograph coded decals may be understood by persons literate in any language. Symbolic pictograph coded decals may be interpreted from a distance and convey more than typed words in the same space.

16. Additional information may be printed onto the decals using alphanumeric character codes to indicate special instructions or service parameters such as “Lube” (lubricate this bearing), “Adjust 0.5” (adjust component to 0.5 mm end play), “IR” (condition monitor temperature by infra red detection) or other statements to direct appropriate monitoring or maintenance activities. With alphanumeric character codes displayed on a decal a technician does not need to refer to a schedule of data spreadsheet searching for relevant information.

17. Computer readable bar-code coding on the decals may allow identification of equipment or components for quick computer entry of relevant date and quick access to a computer data base associated with a particular piece of equipment or equipment component. A technician can save hand transcription time by quickly scanning bar-code coding from a decal with a hand held bar-code reader.

18. Adhesive backed labels are a convenient means to attach task indicator decals to equipment and components. Printing task indicator decals on a computer associated color printer with commonly available adhesive backed printer decal sheets, such as “Avery” labels, provides flexibility and economy.

19. The process of task identifier decal production may be facilitated by computer directed printing in conjunction with a maintenance planner software means. Condition monitoring parameters and preventive maintenance functions, such as equipment identification, condition monitoring tasks, maintenance tasks, inspection periods and special instructions can be input to a maintenance planner software system. The maintenance planner software means then translates the task data into formatted pages for computer directed printing of task indicator decals with appropriate coding. New Task indicator labels can be readily printed and placed at the point of service to give clear notice of changes to the inspection schedule.

20. Task indicator decals are especially well adapted to condition monitoring systems. Task indicator decals help enhance the advantage of condition monitoring plans over preventive maintenance systems by facilitating the functions at periodic inspections. Task indicator decals draw attention to condition monitoring locations, signal the condition monitoring inspection period, indicate the type of activity required, identify the equipment or component and accelerate computer data input and retrieval. Task indicator decals increase the efficiency of condition monitoring systems.

21. A preferred embodiment of task indicator decal use in a condition monitoring systems would be in the manufacturing industries. For example, a conveyor system may have dozens of bearings of many types and similar bearings under widely different forces. Each bearing is assigned an identification number, a condition monitoring inspection period (weekly, monthly, etc.), inspection methods (infra red, vibration, temperature) and preventive maintenance procedures (adjust, lubricate). Printing of unique adhesive backed task indicator decal for each bearing can be directed to a color printer by condition monitoring software. A task indicator decal for a critical high load bearing can be printed with red shading (weekly inspection period); with alphanumeric characters for a unique identity number and IR (infra red monitoring); with an oil can symbolic pictograph (lubricate); and with a bar coded identity number. A task indicator decal for a conveyor system bearing under low loading but important to maintenance of the conveyor belt position can be printed with green shading (monthly monitoring); with alphanumeric characters for a unique identity number and numbers for a gap clearance specification; with a wave symbolic pictograph (vibration monitoring); and with a bar coded identity number. With the task indicator decals adhesively attached to the appropriate bearings, a technician routinely monitors the conveyor system. The technician monitors red decal points of service on a weekly basis. The red decal labeled high load bearing is uniquely identified by a portable barcode reader, monitored for infra red radiation levels then lubricated. As infra red data accumulate, statistical regression analysis may predict imminent failure of the bearing and provide notice for the technician to replace that bearing. The technician monitors green decal points of service on a monthly basis. The green decal labeled low load bearing is uniquely identified by the portable barcode reader, measured for gap clearance, and monitored for vibration levels then adjusted as necessary. Of course, those skilled in the relevant arts can apply obvious variations of coding specific to preventive maintenance and condition monitoring functions in other industrial settings.

### BRIEF DESCRIPTION OF THE DRAWING

22. The drawing shows of a typical variety of task identifier decals that may be applied in industry for use in preventive maintenance and condition monitoring functions.

23. The FIGURE depicts typical task indicator decals including decals with color, suggestive symbols, alphanumeric descriptors and bar-codes. Different decal colors are indicated by shading differences in the drawing.

### DESCRIPTION OF PREFERRED EMBODIMENTS OF THE INVENTION

24. According to one aspect of the present invention, there are provided task indicator decals 1 having a front display surface 2 for imprinting task coding. The task indicator decals having a means for mounting on equipment or equipment components to express preventive maintenance or condition monitoring task data at the point of service. In a preferred embodiment, the task indicator decals 1 provide relevant maintenance or monitoring information, such as required tasks, in the form of symbolic pictograph coding 3. In a preferred embodiment, the task indicator decals 1 are imprinted with brief alphanumeric character coding 4 particularly directing required condition monitoring or maintenance tasks. In a more preferred embodiment, task indicator decals 1 are imprinted with bar-code coding 5 for equipment and component identification allowing convenient reading by portable bar-code readers and thus quick computer means access to condition monitoring or preventive maintenance requirements, input of condition monitoring data, input of maintenance task completion and quick access to equipment maintenance history. In a most preferred form, the task indicator decals 1 are imprinted with color coding 5 to indicate relevant condition monitoring or preventive maintenance inspection periods.

25. In a most preferred form of the invention, the imprinting process of making task indicator decals includes a computer directing printing of task indicator decals on a digital printer in conjunction with a maintenance planner software means. In a preferred form of the invention task indicator decals are imprinted on adhesive backed labels.

The invention claimed is:

1. Task indicator decals to readily convey information for condition monitoring or preventive maintenance functions comprising a decal having a display surface imprinted with coding, the decal having a mounting means for affixing the decal at the point of service.

2. Task indicator decals according to claim 1 further comprising color coding.

3. Task indicator decals according to claim 1 further comprising symbolic pictograph coding.

4. Task indicator decals according to claim 1 further comprising alphanumeric character coding.

5. Task indicator decals according to claim 1 further comprising bar-code coding.

6. Task indicator decals according to claim 1 imprinted on computer printer label sheets having a adhesive backed mounting means.

7. A method of preventative maintenance or condition monitoring using task indicator decals according to any of the claims above.

8. A process of task indicator label production by computer directed printer printing in conjunction with a maintenance planner software means.
